(19) United States
(12) Patent Application Publication
(10) Pub. No.: US 2005/0075109 A1
(43) Pub. Date: Apr. 7, 2005

(54) Method enabling a mobile user switching from a public telecommunication network to a private network to receive calls via the network more appropriate to his location, and devices for implementing the method

(75) Inventors: Nicolas Neyret, St Ferreol (FR); Gerard Vergnaud, Franconville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/784,225

(22) Filed: Feb. 24, 2004

(30) Foreign Application Priority Data
Feb. 25, 2003 (FR) 03 02 266

(51) Int. Cl. H04Q 7/20

(52) U.S. Cl. 455/445

(57) ABSTRACT

A method is disclosed that enables a mobile user having a terminal at least able to connect to a public land mobile network and a terminal at least able to connect to a wireless local area network forming part of a private network, on switching between the public land mobile network and the private network, to receive calls via the network more suited to his location. The method determines if the terminal able to connect to the wireless local area network is present in or absent from the coverage area of the wireless local area network. It activates call forwarding to a predetermined call forwarding number when the terminal at least able to connect to a wireless local area network is present in the coverage area of the wireless local area network and then deactivates call forwarding when the terminal is no longer present in the coverage area of the wireless local area network. For activating call forwarding, the method determines the location of a user in one of a plurality of cells of the wireless local area network, reads a plurality of call forwarding numbers stored in a table at an address corresponding to the user, and selects one of the call forwarding numbers as a function of a presence indication designating one of a plurality of cells constituting the wireless local area network.

### CROSS-REFERENCE TO RELATED APPLICATIONS

This application is based on French Patent Application No. 03 02 266 filed Feb. 25, 2003, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method enabling a mobile user switching from a public wireless telecommunication network to a corporate network to receive calls via the network more suited to his location, the corporate network generally having the advantage of offering additional services and lower call costs.

2. Description of the Prior Art

Nowadays, an employee of a business may have simultaneous access to several telephone terminals. When the user is off the site of the business, there is only one option: to receive calls via a public land mobile network. However, if the user is on the site of the business, he generally has two options. If he has a telephone connected to a fixed network of the business and a GSM mobile telephone, the most economic way to receive calls is via the fixed network of the business. On the premises of the business, his telephone may be a fixed telephone, a Digital European Cordless Telephone (DECT) handset, or a Wireless Local Area Network (WLAN) telephone.

The invention relates more particularly to business networks incorporating a wireless local area network conforming to the IEEE 802.11 (a or b) standard, to the Bluetooth (IEEE 802.15) standard, or to any other standard defining a wireless local area network. A wireless local area network comprises a plurality of radio access points and a plurality of mobile terminals each of which includes means for setting up a radio link with a radio access point. The terminals (microcomputers, personal digital assistants, mobile telephones utilizing the Internet Protocol, etc.) are mobile. They can therefore enter or leave the coverage area of the network, or change access point within the same wireless local area network. To be able to send them data or to set up a voice call to one of them, one prior art method determines continuously which terminals are near each radio access point.

There are dual mode terminals able to operate alternately in a public land mobile network, for example a GSM network, and a wireless local area network, for example one conforming to the IEEE 802.11 (a or b) standard. A dual mode terminal switches automatically to the operating mode corresponding to a wireless local area network when it detects that it is within the coverage area of this kind of local area network, if it is authorized to connect thereto and if the terminal is not engaged in a call via the public network. It may be envisaged that future terminals will also be able to switch from one network to the other during a call.

A business usually also has a network of fixed telephone terminals. If a user has no cordless telephone, it is desirable to route a call to a fixed telephone that is assigned to the user or is not assigned permanently to the user but is near his present location, which may be determined from the location of a data terminal carried by the user concerned (a portable computer or personal digital assistant connected to the wireless local area network).

The document U.S. Pat. No. 5,924,030 describes a system enabling GSM mobile telephone terminals to operate alternately in a GSM public network and in a GSM private network, the two networks being connected via a fixed public telephone network. The GSM public network includes a database for storing the presence of GSM terminals in the coverage area of the private network, using a location process conforming to the GSM standard. Similarly, the GSM private network includes a database for storing the presence of GSM terminals in the coverage area of the private network, using the same location process. When a GSM terminal enters the coverage area of the GSM private network, the terminal sends its international mobile subscriber identifier (IMSI) to a gateway that connects the GSM private network to the GSM public network via the fixed public network. The gateway verifies that at least one fixed network number is available for accessing the GSM private network; if so, the gateway registers the terminal in the database of the GSM private network and then activates call forwarding in the fixed public telephone network, sending the number and the IMSI to the database of the GSM public network, so that any call to the terminal is forwarded to the GSM private network.

The drawback of this prior art system is that it is able to function only if the private network is a GSM network, as it is based on procedures defined in the GSM standard and always uses the same number (the IMSI) and the same GSM terminal, regardless of the location of the user.

The object of the invention is to propose a reliable method of choosing automatically the network most appropriate for communicating with a user who can be contacted via at least two networks of different types, on the one hand a public land mobile network and on the other hand a private wired or wireless network which is not of the same type as the public land mobile network. Clearly, in this case the user will not use the same terminal (or the terminal will be a dual mode terminal equivalent to two terminals), and it will not be possible to call that terminal using the same number as that of the terminal for the public land mobile network.

### SUMMARY OF THE INVENTION

The invention consists in a method enabling a mobile user having a terminal at least able to connect to a public land mobile network and a terminal at least able to connect to a wireless local area network forming part of a private network on switching between the public land mobile network and the private network to receive calls via the network more suited to his location, which method consists in:
determining if the terminal able to connect to the wireless local area network is present in or absent from the coverage area of the wireless local area network, and
activating call forwarding to a predetermined call forwarding number when the terminal at least able to connect to a wireless local area network is present in the coverage area of the wireless local area network and then deactivating call forwarding when the terminal is no longer present in the coverage area of the wireless local area network,
   and which method further consists in, for activating call forwarding:
determining the location of a user in one of a plurality of cells of the wireless local area network,
reading a plurality of call forwarding numbers stored in a table at an address corresponding to the user, and
selecting one of the call forwarding numbers as a function of a presence indication designating one of a plurality of cells constituting the wireless local area network.

The method thus characterized may forward a call:
to the same terminal, but via the wireless local area network, if the user has a dual mode terminal, or
to a cordless second terminal specific to the wireless network, or
to a fixed second terminal in the cell in which the presence of the user has been detected, since the call forwarding number is selected as a function of the precise location of the user, as determined by detecting the presence of a third terminal, such as a portable computer or a personal digital assistant, carried by the user and adapted to be connected to the wireless local area network.

The invention further provides an application server for implementing the above method, the server comprising means for, when a terminal adapted to connect to the wireless local area network becomes present in the coverage area of a wireless local area network:
sending a public land mobile network a call forwarding activation message containing:
   a number specific to a terminal at least able to connect to a public land mobile network and enabling it to be called in the public land mobile network, and
   a call forwarding number, and
sending the public land mobile network a call forwarding deactivation message containing the number specific to the terminal at least able to connect to a public land mobile network and enabling it to be called in the public land mobile network when the terminal adapted to connect to the wireless local area network is no longer present in the coverage area of the wireless local area network,
   in which server the means for sending a public land mobile network a call forwarding activation message include:
a table containing a plurality of call forwarding numbers for at least one user, and
means for selecting one of the call forwarding numbers as a function of a presence indication designating one of a plurality of cells constituting the wireless local area network.

The invention will be better understood and other features of the invention will become apparent in the course of the following description and from the accompanying drawings.

### BRIEF DESCRIPTION OF THE DRAWINGS

FIG. 1 depicts one example of a business network and public networks in which the method of the invention is implemented.

FIG. 2 depicts one example of a table stored in one example of an application server according to the invention.

FIG. 3 is a timing diagram depicting exchange of messages between the components of the networks and the application server depicted in FIG. 1 to adapt the route followed by calls addressed to a user as a function of the location of the user.

FIG. 4 is a timing diagram depicting exchanges of messages within the business network, for the purpose of detecting the presence of terminals, in one embodiment of the method of the invention.

FIG. 5 shows a variant of the method of the invention, relating to the same example of a business network and public networks shown in FIG. 1, but for a user whose second telephone terminal is a fixed telephone.

### DETAILED DESCRIPTION OF THE PREFERRED EMBODIMENTS

The following description does not address the problem of switching from one network to the other during a call that has already been set up, but only the problem of choosing the most suitable network for setting up calls to the user after a change of location of the user.

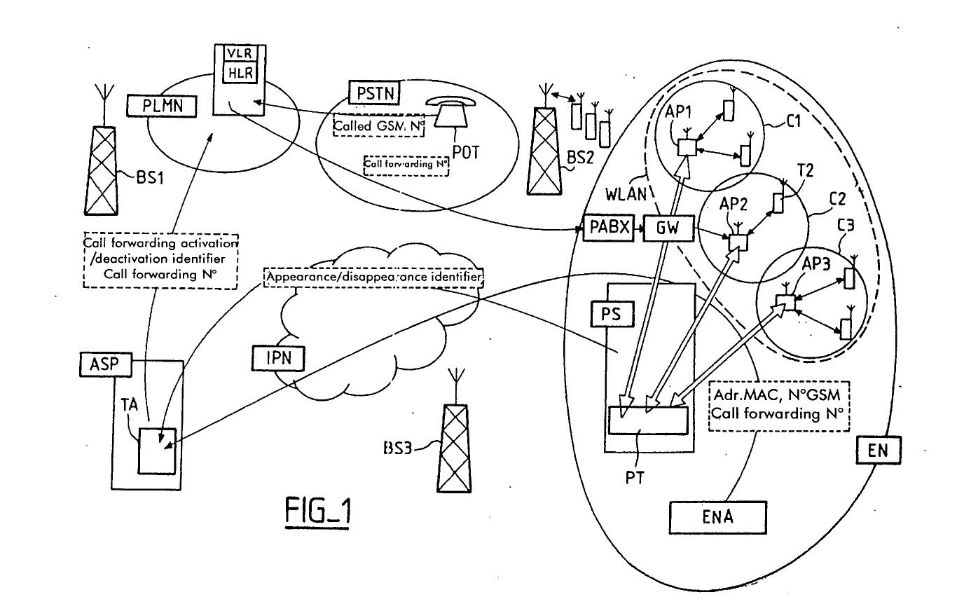

FIG. 1 shows:
a GSM public land mobile network (PLMN) comprising base stations BS1, BS2, BS3, etc., a home location register HLR, and a visitor location register VLR;
a conventional fixed public switched telephone network PSTN, for example an integrated services digital network;
a fixed public telecommunication network IPN utilizing the Internet protocol, for example the Internet;
a business network EN including:
   a private automatic branch exchange PABX,
   a wireless local area network WLAN conforming to the IEEE 802.11 b standard, for example, having three radio access points AP1, AP2, AP3 serving three cells C1, C2, C3, respectively;
   a gateway GW connecting the private automatic branch exchange PABX and the wireless local area network WLAN; and
   a presence server PS according to the invention;
dual mode terminals T2 that can be used alternately in the public land mobile network PLMN and the wireless local area network WLAN of the business network EN; and
an application server ASP belonging to an application service provider and enabling users to receive calls via the network most suited to the location of their respective terminals, in accordance with the invention.

Consider first a particularly appropriate embodiment of the dual mode terminals T2.

The application server ASP modifies the operation of the public land mobile network PLMN by modifying the data in the home location register HLR and in the visitor location register VLR when the dual mode terminal T2 enters or leaves the coverage area of the cells C1, C2, C3 of the wireless local area network WLAN. The application server ASP activates call forwarding to a number designating the same dual mode terminal T2 in the wireless local area network WLAN when the dual mode terminal T2 is in the coverage area of the wireless local area network WLAN and then deactivates call forwarding when the terminal is no longer in the coverage area of the wireless local area network WLAN.

For example, when the presence of the terminal T2 in the cell C2 has been detected, because it is connected to the access point AP2, the server ASP commands the writing into the location registers HLR and VLR of an instruction to forward calls to a call forwarding number N^{o}WLAN 2, enabling the terminal T2 to be contacted via the business network EN instead of via the public land mobile network PLMN.

Then, if a “plain old telephone” POT of the public switched telephone network PSTN calls the terminal T2 by dialing the number N^{o}GSM 2 that designates the terminal in the public land mobile network PLMN, the location registers HLR and VLR command call forwarding to the call forwarding number N^{o}WLAN 2. The private automatic branch exchange PABX sets up a connection to the terminal T2 conventionally, via the gateway GW, which converts pulse code modulation (PCM) frames into Internet protocol data packets, and via the radio access point AP2 of the wireless local area network WLAN.

In a first embodiment, the application server ASP commands activation or deactivation of call forwarding by sending the public land mobile network PLMN a message conforming to the MAP protocol, which is part of the GSM standard. The message contains:
an international mobile subscriber identifier (IMSI) of the terminal, one field of which consists of the telephone number of the user in the public land mobile network PLMN, or a temporary mobile subscriber identifier (TMSI) specific to the terminal T1;
a call forwarding number consisting of the telephone number of the user in the wireless local area network WLAN, if he is using a dual mode terminal; and
a command to activate or deactivate call forwarding.

The message is transmitted over a conventional telephone line by means of two modems situated at the two ends of the line. Because the MAP protocol is used, no modification is necessary in the public land mobile network PLMN to enable use of the method according to the invention. It is sufficient for the application server ASP to have the right to access the location registers HLR and VLR of the public land mobile network PLMN (under an agreement between the operator of the application server ASP and the operator of the public land mobile network PLMN).

In a second embodiment, the application server ASP sends the public land mobile network PLMN a short message system (SMS) message, as defined in the GSM standard, including the same information as above. Thus the application server ASP is seen by the public land mobile network PLMN as a GSM terminal sending an SMS message to command the forwarding of calls addressed to the terminal. The message is transmitted over a conventional telephone line by means of two modems situated at the two ends of the line. Because SMS messages are used, no modification is necessary in the public land mobile network PLMN to enable use of the method according to the invention.

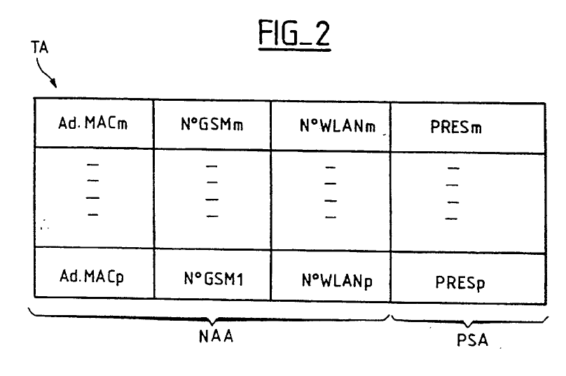

The application server ASP includes software for executing one of the procedures described above and contains a table TA that stores the necessary information. FIG. 2 depicts one example of the table TA, in the case of dual mode terminals. This embodiment includes one line for each user authorized to use the service for selecting the most appropriate network. Each line is identified by an identifier that distinguishes the user. The identifier is supplied to the base station by the terminal and consists of a physical address assigned by the manufacturer of the terminal, for example. However, this is not the only option; the name of the user may be used, for example. For the user of a dual mode terminal Tm, for example, a line contains:
the identifier Ad.MACm supplied by the terminal Tm and identifying the user;
the international mobile subscriber identifier (IMSI) specific to the terminal Tm, consisting essentially of the telephone number N^{o}GSMm of the terminal Tm in the public land mobile network PLMN or the temporary mobile subscriber identifier (TMSI) specific to the terminal T1;
a telephone number N^{o}WLANm specific to the terminal Tm in the wireless local area network WLAN; and
an indicator PRESm having a binary value that indicates the location of the terminal Tm, reflecting its presence in or its absence from the coverage area of the wireless local area network WLAN.

The table TA has two parts:
A part NAA that is accessible by an administrator ENA of the business network EN to write therein the first three items of information listed above, when a new user is authorized to use the service for automatically selecting the network most appropriate to his location, and conversely for erasing such information when a user is no longer authorized.
A part PSA that is accessible by the presence server PS of the business network EN, to write and update therein the presence/absence indicator each time that the presence server PS registers the entry or exit of one of the users authorized to use the service for automatically selecting the network most suited to his location.

The administrator ENA and the presence server PS download this information into the table TA via the Internet IPN.

Consider the situation of a user using two different mobile terminals: a terminal T1 dedicated to the public land mobile network PLMN and a terminal Tp dedicated to the wireless local area network WLAN. The line in the table TA corresponding to this user contains (see FIG. 2):
the identifier Ad.MACp supplied by the terminal Tp and identifying the user;
the international mobile subscriber identifier (IMSI) specific to the terminal T1, consisting essentially of the telephone number N^{o}GSM1 of the terminal T1 in the public land mobile network PLMN, or the temporary mobile subscriber identifier (TMSI) specific to the terminal T1;
a telephone number N^{o}WLANp specific to the terminal Tp in the wireless local area network WLAN; and
an indicator PRESp having a binary value that indicates the location of the terminal Tp, reflecting its presence or its absence in the coverage area of the wireless local area network WLAN.

The situation of a user further using at least one fixed telephone is discussed later.

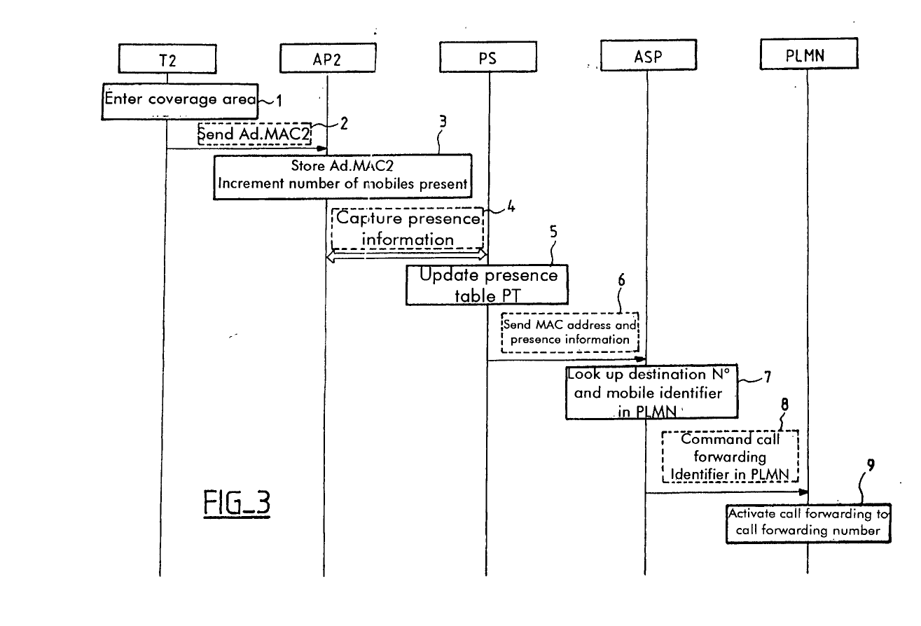

FIG. 3 is a timing diagram depicting exchanges of messages between the various components of the networks depicted in FIG. 1 and the application server ASP when a dual mode terminal T2 enters the cell C2 served by the radio access point AP2 of the wireless local area network WLAN:

1) The terminal T2 enters the cell C2. It detects the presence of the access point AP2 and switches to the operating mode corresponding to the wireless local area network WLAN.

2) It sends the access point AP2 a message containing its physical address Ad. MAC2.

3) The access point AP2 stores the physical address Ad. MAC2.

4) The presence server PS periodically interrogates the radio access points AP1, AP2, AP3, using a procedure described later, to capture the physical addresses of the terminals currently present in the coverage area of the wireless local area network WLAN. It includes a presence table PT that stores respective physical addresses and presence/absence indicators for each of the terminals authorized to use the service. It updates the values of the indicators in the table PT as and when physical addresses of terminals currently present arrive.

6) Each time it updates a presence/absence indicator value, the presence server PS sends the application server ASP a message to update the table TA. In this example, this message contains the physical address Ad.MAC2 and a presence/absence indicator value PRES2 indicating the presence of the terminal T2.

7) The application server ASP updates the table TA, searching for the line that contains the physical address Ad.MAC2 in order to write therein the new value of the presence/absence indicator and to read therein the IMSI N^{o}GSM2 of the terminal T2 in the public land mobile network PLMN and the call forwarding number consisting of the number N^{o}WLAN2 of the terminal T2 in the wireless local area network WLAN.

8) The application server ASP sends a message to the location registers HLR and VLR of the public land mobile network PLMN to command forwarding of calls addressed to the terminal T2. This message contains the IMSI N^{o}GSM2 and the call forwarding number N^{o}WLAN2 read in the table TA and an instruction to activate call forwarding.

9) The call forwarding function becomes active in the public land mobile network PLMN. For a user to be able to receive calls via the network most suited to his location, it is necessary first of all to detect reliably the presence of the user. Prior art protocols for managing wireless local area networks are able to detect the presence of a terminal. They enable a central unit to collect and use information on the whole of a wireless local area network. They are satisfactory for signaling that a terminal has been put into service or taken out of service. On the other hand, they are not satisfactory when a terminal frequently enters and leaves the coverage area of an access point, because it is moving along the border of the coverage area of the wireless local area network. In particular, there is no prior art method of making this choice if the two networks are GSM and IEEE 802.11 networks, for example.

On each entry and each exit of the same terminal, the radio access point that is communicating with the terminal sends a series of messages to the central entity, and these messages continue to be sent for a few seconds after the terminal has definitively entered or left the coverage area. The messages are mutually contradictory because they indicate entries and exits alternately. Existing radio access points are not able to filter these messages. Presence detection is therefore not reliable when a terminal is on the border of the coverage area of a wireless local area network. This is therefore not a satisfactory means of automatically selecting the most appropriate network as a function of the location of a terminal.

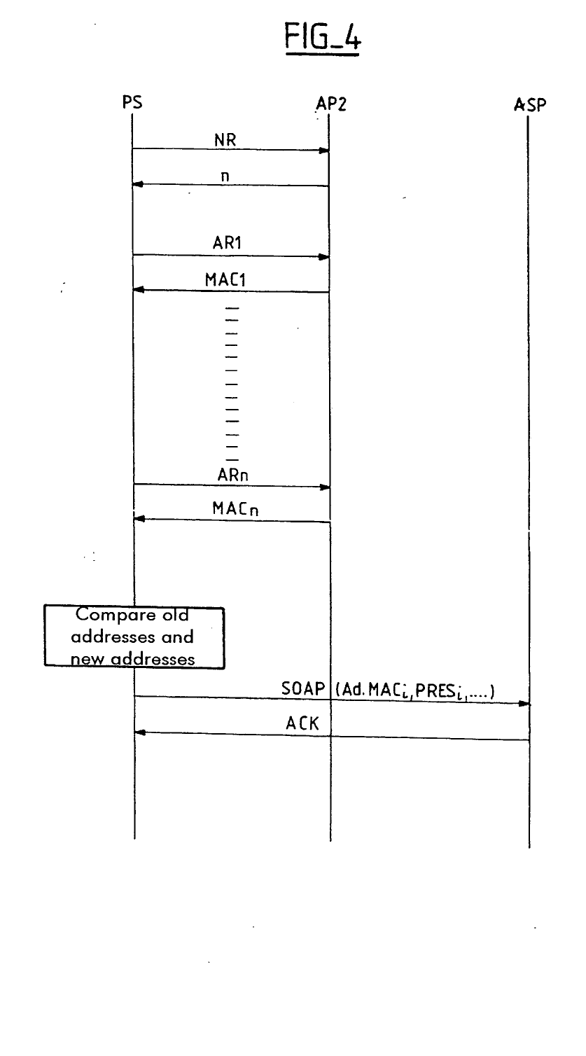

FIG. 4 depicts a preferred embodiment of the method of the invention with regard to detecting the presence of terminals T2 in the coverage area C1, C2, C3 of the wireless local area network WLAN. It depicts the exchanges of messages between the presence server PS, the access point AP2, for example, and the application server ASP. The messages exchanged conform to the Simple Network Management Protocol (SNMP), which is widely used for managing wireless local area networks.

The presence server SP sends a message NR to the successive radio access points AP1, AP2, AP3 at regular intervals, to request an indication n of the number of terminals currently present in the area covered by the access point. Each radio access point, for example AP2, responds by sending a message containing the number n of terminals present in the area that it covers.

Knowing this number n, the presence server SP then sends, for each successive radio access point AP1, AP2, AP3, a series of n messages AR1 to ARn, each message requesting the access point to send a single present terminal physical address. The access point concerned responds to each request with a message containing each time an address that has not yet been sent. It therefore sends n separate messages containing the respective physical addresses Ad.MAC1 to Ad.MACn of the n terminals currently present in the area covered by the access point.

The presence server PS writes these addresses into the presence table PT and compares each address with those previously received, in order to detect terminals that have recently entered and terminals that have recently left.

The presence server PS then sends the application server ASP a message SOAP containing the physical addresses Ad.MACi of the terminals that recently entered and the terminals that recently left, with the corresponding presence/absence indicators PRESi, for updating the table TA of the application server ASP.

The presence server PS obtains a reliable presence detection because it is based on interrogating the terminals, effected by each radio access point but initiated at the initiative of the server PS. Interrogation is therefore triggered independently of terminals entering and leaving the coverage area. Detection is therefore not disturbed by an excessively large number of entries and exits, since these are no longer the events that trigger the presence detection procedure.

This mode of operation of the presence server PS is necessary for reliable detection of presence because current radio access points do not verify the location of a terminal over a certain period. If in the future there are radio access points that carry out more reliable presence detection, the method of the invention could be used without employing the procedure described above with reference to FIG. 4. The presence server PS would then obtain presence information from the access points for immediate use.

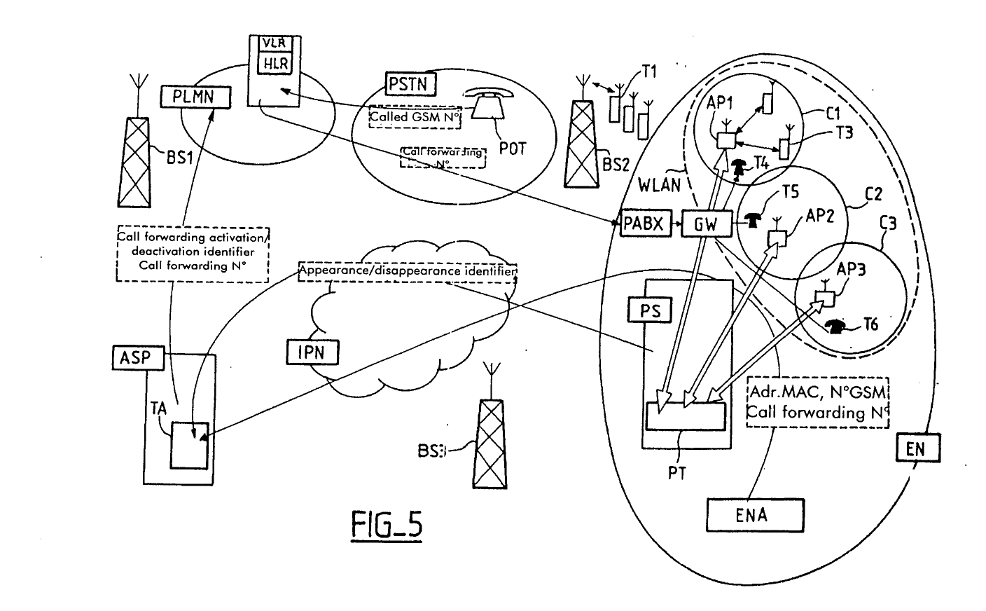

FIG. 5 depicts a variant of the method according to the invention, for the same example of a business network and public networks as FIG. 1, but for a user whose second telephone terminal is a fixed telephone T4. This user has:
a specific GSM mobile telephone terminal T1,
a mobile terminal T3 specific to the wireless local area network WLAN, but with no telephone functions (for example a personal digital assistant having a radio interface), and
a fixed telephone terminal T4 connected to the private automatic branch exchange PABX by a cable.

In this variant, the terminal T3 is used not only to detect the presence of the user in the coverage area of the wireless local area network WLAN but also to determine in which of the cells C1, C2, C3 he is located. If the user is in the cell C1, calls to him are forwarded to the fixed terminal T4. If the user is in the cell C2, calls to him are forwarded to the fixed terminal T5. If the user is in the cell C3, calls to him are forwarded to the fixed terminal T6.

The presence server PS stores this additional information in its table PT. It informs the application server ASP each time that it registers a change of cell or an exit from the wireless local area network WLAN. The presence/absence indicator PRESi no longer has a binary value. It comprises several bits to code all possible locations plus absence. In the table TA, the field containing a call forwarding number N^{o}WLANi is replaced by a field able to contain three call forwarding numbers corresponding to the fixed telephones T4, T5, T6, respectively. The application server ASP commands call forwarding again each time that the presence server PS sends it a message indicating a change of cell and the call forwarding number is the number of the fixed telephone corresponding to the new cell, as indicated by the new value of the indicator PRESi.

In a variant, the table TA may be situated elsewhere than in the application server ASP. It may be divided into a plurality of portions corresponding to respective different businesses. Each portion is then stored in a server situated in a different business, and the application server ASP then uses the Light Directory Application Protocol (LDAP) to process the distributed table.

The invention relates to users having a dual mode terminal, and also:

Users having two terminals respectively specific to the two wireless modes: for example, a GSM telephone terminal and a portable computer having telephone functions and a radio interface for connecting to a wireless local area network.

Users having a specific GSM telephone terminal, a fixed telephone terminal, and a data terminal having a radio interface for connecting to a wireless local area network, but having no telephone function.

1. A method enabling a mobile user having a terminal at least able to connect to a public land mobile network and a terminal at least able to connect to a wireless local area network forming part of a private network on switching between said public land mobile network and said private network to receive calls via the network more suited to his location, which method consists in:
determining if said terminal able to connect to said wireless local area network is present in or absent from the coverage area of said wireless local area network, and
activating call forwarding to a predetermined call forwarding number when said terminal at least able to connect to a wireless local area network is present in said coverage area of said wireless local area network and then deactivating call forwarding when said terminal is no longer present in said coverage area of said wireless local area network, and which method further consists in, for activating call forwarding:
determining the location of a user in one of a plurality of cells of said wireless local area network,
reading a plurality of call forwarding numbers stored in a table at an address corresponding to said user, and
selecting one of said call forwarding numbers as a function of a presence indication designating one of a plurality of cells constituting said wireless local area network.

2. The method claimed in claim 1 further comprising writing in said table, for each user authorized to receive calls via the network more suited to his location:
a number specific to said terminal at least able to connect to a public land mobile network and enabling said terminal to be called in said public land mobile network,
a plurality of call forwarding numbers corresponding to a plurality of respective cells of said wireless local area network in which said user may be located, and
a presence indication designating one of a plurality of cells constituting said wireless local area network.

3. The method claimed in claim 2, further comprising writing in a table of an application server a new presence indication for each user whose location has changed.

4. The method claimed in claim 1 wherein a call forwarding number corresponds to a terminal of a fixed network.

5. The method claimed in claim 1 wherein, to determine the location of a user in the coverage area of a wireless local area network, it comprises the steps of:
obtaining from each successive radio access point of a wireless local area network the number of terminals present in its coverage area,
then, for each radio access point of said wireless local area network, obtaining n times from said access point an identifier specific to a terminal, where n is the number of terminals present in the coverage area of said radio access point, and
receiving and then storing said identifiers and comparing them with identifiers previously stored to deduce from the result of the comparison which terminals have become present and which terminals have become absent in the coverage area of said wireless local area network.

6. An application server for implementing a method as claimed in claim 1, said server comprising means for, when a terminal adapted to connect to said wireless local area network becomes present in the coverage area of a wireless local area network:
sending a public land mobile network a call forwarding activation message containing:
a number specific to a terminal at least able to connect to a public land mobile network and enabling it to be called in said public land mobile network, and
a call forwarding number, and
sending said public land mobile network a call forwarding deactivation message containing said number specific to said terminal at least able to connect to a public land mobile network and enabling it to be called in said public land mobile network when said terminal adapted to connect to said wireless local area network is no longer present in the coverage area of said wireless local area network,
in which server said means for sending a public land mobile network a call forwarding activation message include:
a table containing a plurality of call forwarding numbers for at least one user, and
means for selecting one of said call forwarding numbers as a function of a presence indication designating one of a plurality of cells constituting said wireless local area network.
